(19) United States
(12) Patent Application Publication
(10) Pub. No.: US 2025/0113242 A1
(43) Pub. Date: Apr. 3, 2025

(54) NETWORK DATA ANALYTICS FUNCTION TO DELIVER QUALITY OF EXPERIENCE FOR CELLULAR NETWORK SYSTEM

(71) Applicant: DISH WIRELESS L.L.C., Englewood, CO (US)

(72) Inventors: Mehdi ALASTI, Englewood, CO (US); Kazi BASHIR, Englewood, CO (US); Siddhartha CHENUMOLU, Englewood, CO (US)

(73) Assignee: DISH WIRELESS L.L.C., Englewood, CO (US)

(21) Appl. No.: 18/375,698

(22) Filed: Oct. 2, 2023

(51) Int. Cl. H04W 28/02; H04W 28/08; H04W 28/24

(52) U.S. Cl. CPC H04W 28/0268; H04W 28/0967; H04W 28/24

(57) ABSTRACT

A method for improving quality of experience (QoE) of a user of a cellular network is disclosed. The QoE of the user is monitored using key performance indicator (KPI) data stored in a quality of service (QoS) parameter database. Using data analytics, network configuration parameters are determined in response to determining that the monitored QoE is below a predetermined threshold set for the user. The determined network configuration parameters are adjusted until the monitored QoE reaches the predetermined threshold.

### BACKGROUND

Demand for mobile bandwidth continues to grow as customers access new services and applications. To remain competitive, telecommunications companies must cost-effectively expand their network while also improving user experience.

A measure of overall level of customer satisfaction is called the Quality of Experience (QoE). The QoE allows the network administrator to measure performance from the end-user perspective to gain a better understanding of human quality metrics and be able to actually measure whether performance met a user's expectations.

### SUMMARY

Various embodiments provide solutions to optimize the QoE in cellular network systems such as 4G and 5G networks. As a high level overview, the cellular network (1) monitors the QoE (e.g., mean opinion score (MOS) & other key performance indicators (KPIs)) of services for the user, (2) uses data analytics, (e.g., network data analytics function (NWDAF) (plus the RAN intelligent controller (RIC)) to check the observed QoE for the user, and (3) combines the QoE with other parameters to make intelligent adjustments, such as dynamic slice configuration and optimization as well as quality of service (QoS) attributes adjustments or pro-actively adapt the resource allocation for a given time window for the user. This can be done in order to meet the requirements of the user's service level agreement (SLA).

According to an embodiment, disclosed is a method for improving quality of experience (QoE) of a user of a cellular network. The quality of experience (QoE) of a user of cellular services of the RAN is monitored using key performance indicator (KPI) data stored in a quality of service (QoS) parameter database. Using data analytics, network configuration parameters are determined in response to determining that the monitored QoE is below a predetermined threshold set for the user. The determined network configuration parameters (e.g. QoS parameters, etc.) are then adjusted until the monitored QoE reaches the predetermined threshold.

According to one embodiment, a cellular network system includes: a radio access network (RAN). The RAN includes (1) cell sites configured to deliver key performance indicator (KPI) data to a quality of service (QoS) parameter database; and (2) a core network comprising a network data analytics function (NWDAF). The NWDAF is configured to monitor quality of experience (QoE) of a user of cellular services of the RAN using the KPI data from the QoS parameter database. The NWDAF is further configured to determine, using data analytics, network configuration parameters to adjust in response to determining that the monitored QoE is below a predetermined threshold set for the user; and adjust the determined network configuration parameters until the monitored QoE reaches the predetermined threshold.

According to one embodiment, a server is disclosed that is configured to communicate with a radio access network (RAN) that includes cell sites and a core network. The server includes a processor configured to perform a network data analytics function (NWDAF). Such NWDAF is configured to monitor quality of experience (QoE) of a user of cellular services of the RAN using key performance indicator (KPI) data stored in a quality of service (QoS) parameter database. The NWDAF also determines, using data analytics, network configuration parameters to adjust in response to determining that the monitored QoE is below a predetermined threshold set for the user; and adjusts the determined network configuration parameters until the monitored QoE reaches the predetermined threshold.

### BRIEF DESCRIPTION OF THE DRAWINGS

Aspects of the present invention are further described in the detailed description which follows in reference to the noted plurality of drawings by way of non-limiting examples of embodiments of the present invention in which like reference numerals represent similar parts throughout the several views of the drawings and wherein:

FIG. 1 illustrates a high level block diagram showing a 5G cellular network using vDUs and a vCU.

FIG. 2 illustrates a high level block diagram showing a 5G cellular network with clusters.

FIG. 3 illustrates a block diagram of the system of FIG. 2 but further illustrating details of cluster configuration software, according to various embodiments.

FIG. 4 illustrates a system for monitoring and adjusting QoE in a cellular network system, according to various embodiments.

FIG. 5 illustrates a method for monitoring and adjusting QoE in a cellular network, in accordance with some embodiments.

### DETAILED DESCRIPTION OF EMBODIMENTS

Broadly speaking, embodiments of the present invention provide methods, apparatuses and computer implemented systems for configuring a cellular network, such as a 5G network, to optimize a user's QoE by monitoring the QoE in real time and making real time adjustments to the network parameters for such user. Such implementation may be done using cloud computing in combination with servers at cell sites, cellular towers and clusters (e.g., kubernetes clusters) that stretch from a public network to a private network, where each cluster has containerized applications.

The below will first explain the configuration of such a cellular system and then go into the method and operation to implement the QoE monitoring and optimization.

### Establishing a Cellular Network Using Containerized Clusters

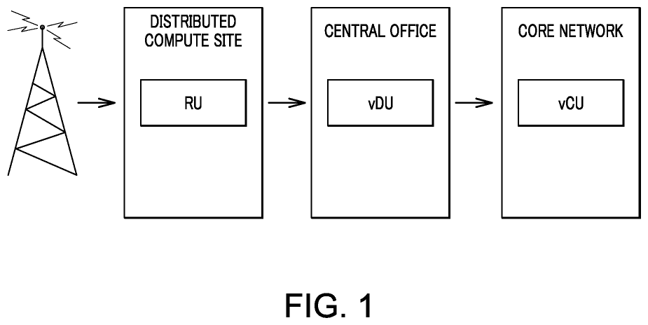

First, a discussion of a configuration of the above-mentioned cellular network will be described referring to FIGS. 1-3.

To begin, the cellular network configuration is established by a plurality of clusters that each employ containerized applications. It should be understood that the present invention should not be limited to clusters and any cellular network configuration could instead be employed. In other words, the below description describes embodiments of the invention with regard to using clusters but the present invention should not be limited to clusters.

A cluster may be part of a set of nodes that run containerized applications. Containerizing applications is an operating system-level virtualization method used to deploy and run distributed applications without launching an entire virtual machine (VM) for each application.

A cluster configuration software is available at a cluster configuration server. This guides a user, such as system administrator, through a series of software modules for configuring hosts of a cluster by defining features and matching hosts with requirements of features so as to enable usage of the features in the cluster. The software automatically mines available hosts, matches host with features requirements, and selects the hosts based on host-feature compatibility. The selected hosts are configured with appropriate cluster settings defined in a configuration template to be part of the cluster. The resulting cluster configuration provides an optimal cluster of hosts that are all compatible with one another and allows usage of various features. Additional benefits can be realized based on the following detailed description.

The present application uses such containerized applications (e.g., clusters) to deploy a RAN so that the virtual distributed unit (“vDU”) (also referred to herein as the “DU”) of the RAN is located at one cluster and the virtual centralized unit (“vCU”) (also referred to herein as the “CU”) is located at a remote location from the vDU, according to some embodiments. This configuration allows for a more stable and flexible configuration for the RAN.

It should be understood that the present application is equally applicable to an O-RAN and thus, whenever the description herein refers to “RAN”, it should also be understood that the description equally works with an O-RAN.

With the above overview in mind, the following description sets forth numerous exemplary details in order to provide an understanding of at least some embodiments of the present invention. It will be apparent, however, to one skilled in the art that the present invention may be practiced without some or all of these details described herein and thus, should not be limited. Operations may be done in different orders, and may or may not include some of the processes described herein. Several exemplary embodiments of the invention will now be described in detail with reference to the accompanying drawings.

FIG. 1 illustrates a system that delivers full RAN functionality using network functions virtualization (NFV) infrastructure. In the embodiment shown in FIG. 1, the RAN includes a tower, radio unit (RU), a DU, a CU, and an element management system (EMS) (not shown). This approach decouples baseband functions from the underlying hardware and creates a software fabric. Within the solution architecture, virtualized baseband units (vBBU) process and dynamically allocate resources to remote RUs based on the current network needs. Baseband functions are split between CU, DUs and RUs that can be deployed in aggregation centers or in central offices (or data centers) using a distributed architecture, such as using clusters as discussed herein.

The virtualized CUs and DUs run as virtual network functions (VNFs) within the NFV infrastructure. The entire software stack that is needed is provided for NFV, including open source software. This software stack and distributed architecture increases interoperability, reliability, performance, manageability, and security across the NFV environment.

RAN standards may have deterministic, low-latency, and low-jitter signal processing, in some embodiments. These may be achieved using containerized applications (e.g., clusters) to control respective DUs, RUs and towers. Moreover, the RAN may support different network topologies, allowing the system to choose the location and connectivity of all network components. Thus, the system allowing various DUs on containerized applications (e.g., clusters) allows the network to pool resources across multiple cell sites, scale capacity based on conditions, and ease support and maintenance requirements.

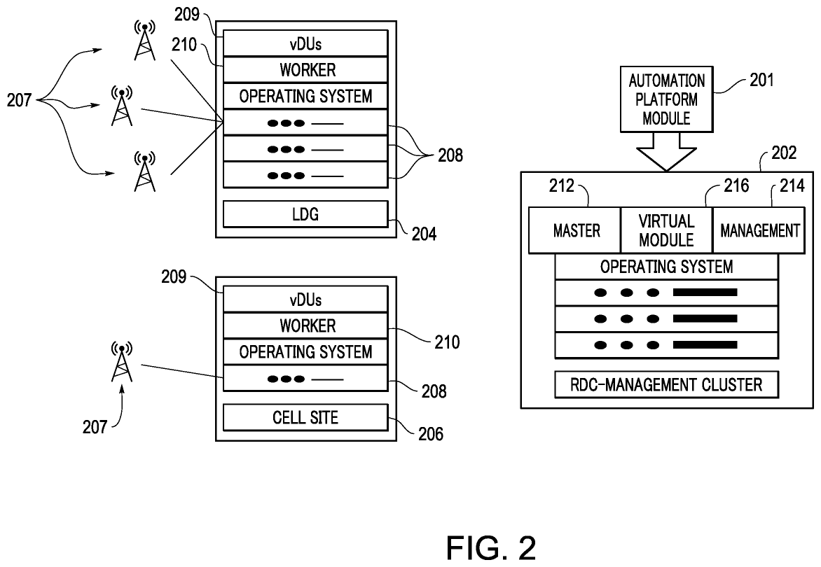

FIG. 2 illustrates an exemplary system used in constructing clusters that allows a network to control cell sites, in one embodiment of the invention. The system includes a cluster configuration server that can be used by a cell site to provide various containers for processing of various functions. Each of the cell sites are accessed via at least one cellular tower (and RRU) by the client devices, which may be any computing device which has cellular capabilities, such as a mobile phone, computer or other computing device.

As shown, the system includes an automation platform (AP) module 201, a remote data center (RDC) 202, one or more local data centers (LDC), and one or more cell sites 206.

The cell sites 206 provide cellular service to the client devices through the use of a vDU 209, server 208, and a tower 207. The server 208 at a cell site 206 controls the vDU 209 located at the cell site 206, which in turn controls communications from the tower 207. Each DU 209 is software to control the communications with the towers 207, RUs, and CU so that communications from client devices (not shown) can communicate from one tower 207 through the clusters to another cellular tower 207. In other words, the voice and data from a cellular mobile client device connects to the towers 207 and then goes through the DU 209 to transmit such voice and data to another DU 209 to output such voice and data to another tower 207 using workers 210 networked via a core network/CU.

The server(s) 208 on each individual cell site 206 or LDC 204 may not have enough computing power to run a control plane that supports the functions in the mobile telecommunications system to establish and maintain the user plane. As such, the control plane may be run in a location that is remote from the cell cites 206, such as the RDC 202.

The RDC 202 is the management cluster which manages the LDC 204 and a plurality of cell sites 206. As mentioned above, the control plane may be deployed in the RDC 202. The control plane maintains the logic and workloads in the cell sites 206 from the RDC 202 while each of the containerized applications (e.g., containers) is deployed at the cell sites 206. The control plane also monitors the workloads that are running properly and efficiently in the cell sites 206 and fixes any workload failures. If the control plane determines that a workload fails at the cell site 206, for example, the control plane redeploys the workload on the cell site 206.

The RDC 202 may include a master 212 (e.g., master), a management module 214 and a virtual (or virtualization) module 216. The master module 212 monitors and controls the workers 210 (also referred to herein as workers) and the applications running thereon, such as the DUs 209. If a DU 209 fails, the master module 212 recognizes this, and will redeploy the DU 209 automatically. In this regard, the clusters system has intelligence to maintain the configuration, architecture and stability of the applications running. Accordingly, the clusters system may be considered to be “self-healing”.

The management module 214 along with the Automation Platform 201 creates the clusters in the LDCs 204 and cell sites 206.

For each of the servers 209 in the LDC 204 and the cell sites 206, an operating system is loaded in order to run the workers 210. For example, such software could be ESKi and Photon OS. The DUs are also software, as mentioned above, that runs on the workers 210. In this regard, the software layers are the operating system, the workers 210, and then the DUs 209 as illustrated in FIG. 2.

The automation platform module 201 includes a GUI that allows a user to initiate clusters. The automation platform module 201 communicates with the management module 214 so that the management module 214 may create the clusters and a master module 212 for each cluster.

Prior to creating each of the clusters, the virtualization center 216 module creates a virtual machine (VM) so that the clusters can be created. VMs and containers are parts of the containerized applications (e.g., clusters) infrastructure of data centers and cell sites. VMs are emulations of particular computer systems that operate based on the functions and computer architecture of real or hypothetical computers. A VM is equipped with a full server hardware stack that has been virtualized. Thus, a VM includes virtualized network adapters, virtualized storage, a virtualized CPU, and a virtualized BIOS. Since VMs include a full hardware stack, each VM may include a complete operating system (OS) to function, and VM instantiation thus may need booting a full OS.

In addition to VMs, which provide abstraction at the physical hardware level (e.g., by virtualizing the entire server hardware stack), containers are created on top of the VMs. Containers provide abstraction at the OS level. In most container systems, the user space is also abstracted. Application presentation systems create a segmented user space for each instance of an application. Applications may be used, for example, to deploy an office suite to dozens or thousands of remote workers. In doing so, these applications create sandboxed user spaces on a server for each connected user. While each user shares the same operating system instance including kernel, network connection, and base file system, each instance of the office suite has a separate user space.

In any event, once the VMs and containers are created, the master modules 212 then create a DU 209 for each VM, as will be described later herein.

FIG. 2 also shows an LDC 204. In some embodiments, the LDC 204 is a data center that can support multiple servers and multiple towers for cellular communications. The LDC 204 is similar to the cell sites 206 except that each LDC 204 has multiple servers 208 corresponding to multiple towers 207 whereby each cell site 206 may only have a single server. Each server in the LDC 204 (as compared with the server in each cell site 206) may support multiple towers. The server 208 in the LDC 204 may be different from the server 208 in the cell site 206 because the servers 208 in the LDC 204 are larger in memory and processing power (number of cores, etc.) relative to the servers 208 in the individual cell sites 206. In this regard, each server 208 in the LDC 204 may run multiple DUs (e.g., 2 DUs), where each of these DUs independently operates a cell tower 207. Thus, multiple towers 207 can be operated through the LDCs 204 using multiple DUs using the clusters. The LDCs 204 may be placed in bigger metropolitan areas whereas individual cell sites 206 may be placed at smaller population areas.

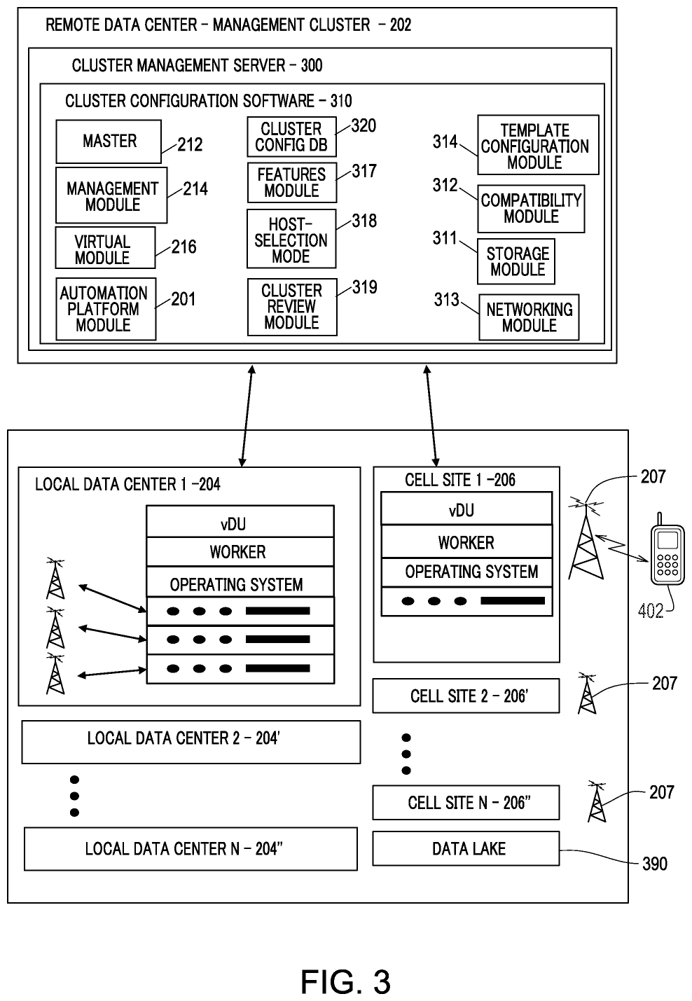

FIG. 3 illustrates a block diagram of the system of FIG. 2 but further illustrating details of cluster configuration software, according to various embodiments.

As illustrated, a cluster management server 300 is configured to run the cluster configuration software 310. The cluster configuration software 310 runs using computing resources of the cluster management server 300. The cluster management server 300 is configured to access a cluster configuration database 320. In one embodiment, the cluster configuration database 320 includes a host list with data related to a plurality of hosts including information associated with hosts, such as host capabilities. For instance, the host data may include a list of hosts accessed and managed by the cluster management server 300, and for each host, a list of resources defining the respective host's capabilities. Alternately, the host data may include a list of every host in the entire virtual environment and the corresponding resources or may include only the hosts that are currently part of an existing cluster and the corresponding resources. In an alternate embodiment, the host list is maintained on a server that manages the entire virtual environment and is made available to the cluster management server 300.

In addition to the data related to hosts, the cluster configuration database 320 includes features list with data related to one or more features including a list of features and information associated with each of the features. The information related to the features include license information corresponding to each feature for which rights have been obtained for the hosts, and a list of requirements associated with each feature. The list of features may include, for example and without limitations, live migration, high availability, fault tolerance, distributed resource scheduling, etc. The list of requirements associated with each feature may include, for example, host name, networking and storage requirements. Information associated with features and hosts are obtained during installation procedure of respective components prior to receiving a request for forming a cluster.

Each host is associated with a local storage and is configured to support the corresponding containers running on the host. Thus, the host data may also include details of containers that are configured to be accessed and managed by each of the hosts. The cluster management server 300 is also configured to access one or more shared storage and one or more shared network.

The cluster configuration software 310 includes one or more modules to identify hosts and features and manage host-feature compatibility during cluster configuration. The configuration software 310 includes a compatibility module 312 that retrieves a host list and a features list from the configuration database 320 when a request for cluster construction is received from the client. The compatibility module 312 checks for host-feature compatibility by executing a compatibility analysis which matches the feature requirements in the features list with the hosts capabilities from the host list and determines if sufficient compatibility exists for the hosts in the host list with the advanced features in the features list to enable a cluster to be configured that can utilize the advanced features. Some of the compatibilities that may be matched include hardware, software and licenses.

It should be noted that the aforementioned list of compatibilities are exemplary and should not be construed to be limiting. For instance, for a particular advanced feature, such as fault tolerance, the compatibility module checks whether the hosts provide a compatible processor family, host operating system, hardware virtualization enabled in the BIOS, and so forth, and whether appropriate licenses have been obtained for operation of the same. Additionally, the compatibility module 312 checks to determine if networking and storage requirements for each host in the cluster configuration database 320 are compatible for the selected features or whether the networking and storage requirements may be configured to make them compatible for the selected features. In one embodiment, the compatibility module checks for basic network requirements. This might entail verifying each host's connection speed and the subnet to determine if each of the hosts has the desired speed connection and access to the right subnet to take advantage of the selected features. The networking and storage requirements are captured in the configuration database 320 during installation of networking and storage devices and are used for checking compatibility.

The compatibility module 312 identifies a set of hosts accessible to the management server 300 that either matches the requirements of the features or provides the best match and constructs a configuration template that defines the cluster configuration settings or profile that each host needs to conform in the configuration database 320. The configuration analysis provides a ranking for each of the identified hosts for the cluster. The analysis also presents a plurality of suggested adjustments to particular hosts so as to make the particular hosts more compatible with the requirements. The compatibility module 312 selects hosts that best match the features for the cluster. The cluster management server 300 uses the configuration settings in the configuration template to configure each of the hosts for the cluster. The configured cluster allows usage of the advanced features during operation and includes hosts that are most compatible with each other and with the selected advanced features.

In addition to the compatibility module 312, the configuration software 310 may include additional modules to aid in the management of the cluster including managing configuration settings within the configuration template, addition/deletion/customization of hosts and to fine-tune an already configured host so as to allow additional advanced features to be used in the cluster. Each of the modules is configured to interact with each other to exchange information during cluster construction. For instance, a template configuration module 314 may be used to construct a configuration template to which each host in a cluster may conform based on specific feature requirements for forming the cluster. The configuration template is forwarded to the compatibility module which uses the template during configuration of the hosts for the cluster. The host configuration template defines cluster settings and includes information related to network settings, storage settings and hardware configuration profile, such as processor type, number of network interface cards (NICs), etc. The cluster settings are determined by the feature requirements and are obtained from the Features list within the configuration database 320.

A configuration display module may be used to return information associated with the cluster configuration to the client for rendering and to provide options for a user to confirm, change or customize any of the presented cluster configuration information. In one embodiment, the cluster configuration information within the configuration template may be grouped in sections. Each section can be accessed to obtain further information regarding cluster configuration contained therein.

A features module 317 may be used for mining features for cluster construction. The features module 317 is configured to provide an interface to enable addition, deletion, and/or customization of one or more features for the cluster. The changes to the features are updated to the features list in the configuration database 320. A host-selection module 318 may be used for mining hosts for cluster configuration. The host-selection module 318 is configured to provide an interface to enable addition, deletion, and/or customization of one or more hosts. The host-selection module 318 is further configured to compare all the available hosts against the feature requirements, rank the hosts based on the level of matching and return the ranked list along with suggested adjustments to a cluster review module 319 for onward transmission to the client for rendering.

The cluster review module 319 may be used to present the user with a proposed configuration returned by the host-selection module 318 for approval or modification. The configuration can be fine-tuned through modifications in appropriate modules during guided configuration set-up which are captured and updated to the host list in either the configuration database 320 or the server. The suggested adjustments may include guided tutorial for particular hosts or particular features. In one embodiment, the ranked list is used in the selection of the most suitable hosts for cluster configuration. For instance, highly ranked hosts or hosts with specific features or hosts that can support specific applications may be selected for cluster configuration. In other embodiments, the hosts are chosen without any consideration for their respective ranks. Hosts can be added or deleted from the current cluster. In one embodiment, after addition or deletion, the hosts are dynamically re-ranked to obtain a new ranked list. The cluster review module 312 provides a tool to analyze various combinations of hosts before selecting the best hosts for the cluster.

A storage module 311 enables selection of storage requirements for the cluster based on the host connectivity and provides an interface for setting up the storage requirements. Shared storage may be needed in order to take advantage of the advanced features. As a result, one should determine what storage is shared by all hosts in the cluster and use only those storages in the cluster in order to take advantage of the advanced features. The selection options for storage include all the shared storage available to every host in the cluster. The storage interface provides default storage settings based on the host configuration template stored in the configuration database 320 which is, in turn, based on compatibility with prior settings of hosts, networks and advanced features and enables editing of a portion of the default storage settings to take advantage of the advanced features. In one embodiment, if a certain storage is available to only a selected number of hosts in the cluster, the storage module 311 will provide necessary user alerts in a user interface with tutorials on how to go about fixing the storage requirement for the configuration in order to take advantage of the advanced features. The storage module performs edits to the default storage settings based on suggested adjustments. Any updates to the storage settings including a list of selected storage devices available to all hosts of the cluster are stored in the configuration database 320 as primary storage for the cluster during cluster configuration.

A networking module 313 enables selection of network settings that is best suited for the features and provides an interface for setting up the network settings for the cluster. The networking module provides default network settings, including preconfigured virtual switches encompassing several networks, based on the host configuration template stored in the cluster configuration database, enables selecting/editing the default network settings to enter specific network settings that can be applied/transmitted to all hosts, and provides suggested adjustments with guided tutorials for each network options so a user can make informed decisions on the optimal network settings for the cluster to enable usage of the advanced features. The various features and options matching the cluster configuration requirements or selected during network setting configuration are stored in the configuration database and applied to the hosts so that the respective advanced features can be used in the cluster.

FIG. 3 also illustrates cell sites 206, 206′, 206″ that are configured to be clients of each cluster. Each cell site 206, 206′, 206″ is shown as includes a cellular tower 207 and a connection to each distributed unit (DU), similar to FIG. 2. Each DU may be a virtualized distributed unit 209, similar to FIG. 2, and each DU may run as virtual network functions (VNFs) within the an open source network functions virtualization (NFV) infrastructure.

Each of the cellular towers 207 is configured to communicate via antenna communications to/from mobile devices 402, such as mobile phones, tablets, computing devices, IOT devices, and any other device with cellular communications capabilities. The communication is received via analog signals and then may be converted into digital signals which are then transmitted to the DU of a cluster associated with the cellular tower from which the communications were received. The DU then processes/transmits the data from signals as discussed herein.

### NWDAF

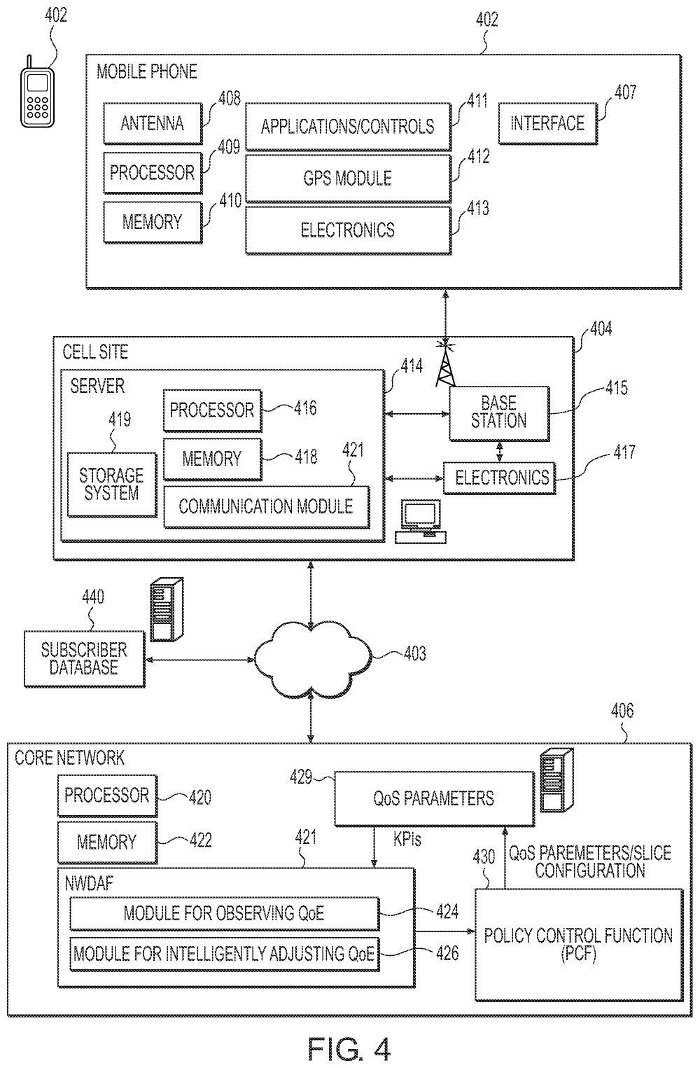

With the above overview of the various components of a system used in the cluster configuration, specific details of that exemplary system, as shown in FIG. 4, are further discussed below. However, prior to discussing FIG. 4, the following background is provided.

QoE is a measure of overall level of customer satisfaction. In other words, QoE is a measure of how a customer perceives his/her experience. Thus, it is desired to optimize the QoE, especially in cellular network systems.

4G and 5G packet networks use Quality of Service (QoS) as a key performance indicator (KPI) to deliver the service level agreement (SLA). Various parameters make up the QoS. For example, in 5G cellular systems, some parameters may be: maximum bit rate, guaranteed bit rate, latency, jitter, packet loss, priority, etc. The QoS parameters are selected based on the service/application requirements and the user's profile.

QoE in cellular systems are measured to ensure high quality or to detect when the quality is low and adjustments need to be made. For example, voice QoE can be measured based on a mean opinion score (MOS). Moreover, each voice call uses different voice-coder (vocoder) and for each vocoder, there may various QoS parameter issues (e.g., bit rate, delay, jitter, packet loss, etc.). In this regard, for each vocoder, the MOS is a function of these QoS parameters. Accordingly, the MOS is calculated based on the QoS parameters. The MOS may typically range from 1-5 whereby 4 or 5 may reflect an excellent voice call quality, but a MOS of 1 may be poor voice quality.

The network may automatically determine the QoS parameters using the observability framework and receiving data analytics. Then, the network may automatically calculate the MOS for a particular call or area. MOS can be determined using the RTCP (real time control protocol) which is in the user plane.

As mentioned above, the QoE depends on the user experience. However, the QoE may also depend on the user's profile, time of day the call is being made, the user's location during the call, the slice being used for the call, etc. The user's profile may include the user's SLA MOS level or other information about the user that may affect the user's service level. The QoE parameters are discussed more in depth later.

After the MOS is calculated, the network can check the MOS to determine if the MOS is below a threshold, and depending on the QoE, the network can intelligently adjust the QoS parameters efficiently to deliver the target QoS.

The network data analytics function (NWDAF) (plus the RAN intelligent controller (RIC)) is the intelligent engine of the RAN that is configured to receive the QoE measurements, user profile and the other information and make the intelligent adjustment in QoS parameters. The intelligent adjustments are discussed later herein.

Also, if the QoE is high, the network may determine that more users can be added to the slice and not give up QoE until the QoE starts dropping below a threshold.

When setting up a service level agreement (SLA) with the network, users will sign up for a particular MOS level. Users can request a high/premium, medium/standard, or basic MOS when setting up their service with the network. This MOS service request will determine the level of service or quality the user will receive.

For example, for users that sign up to request a predefined high MOS (e.g., 4.3) as opposed to users that sign up for a predefined lower MOS (e.g., 2.5), those who requested the predefined high MOS through their SLA will have a higher level of QoE because the network parameters will be optimized better for those users relative to the network parameters preset for the predefined low MOS users.

However, the network can charge more for those predefined high MOS users relative to the predefined low MOS users. In effect, the predefined high MOS users pay a premium for the higher quality of service and thus, higher QoE.

While this can be done at the time of initial setup of the user's SLA, the SLA can also be modified after initial setup of the SLA (e.g., during the user's experience with the network but before the end of the SLA expiration).

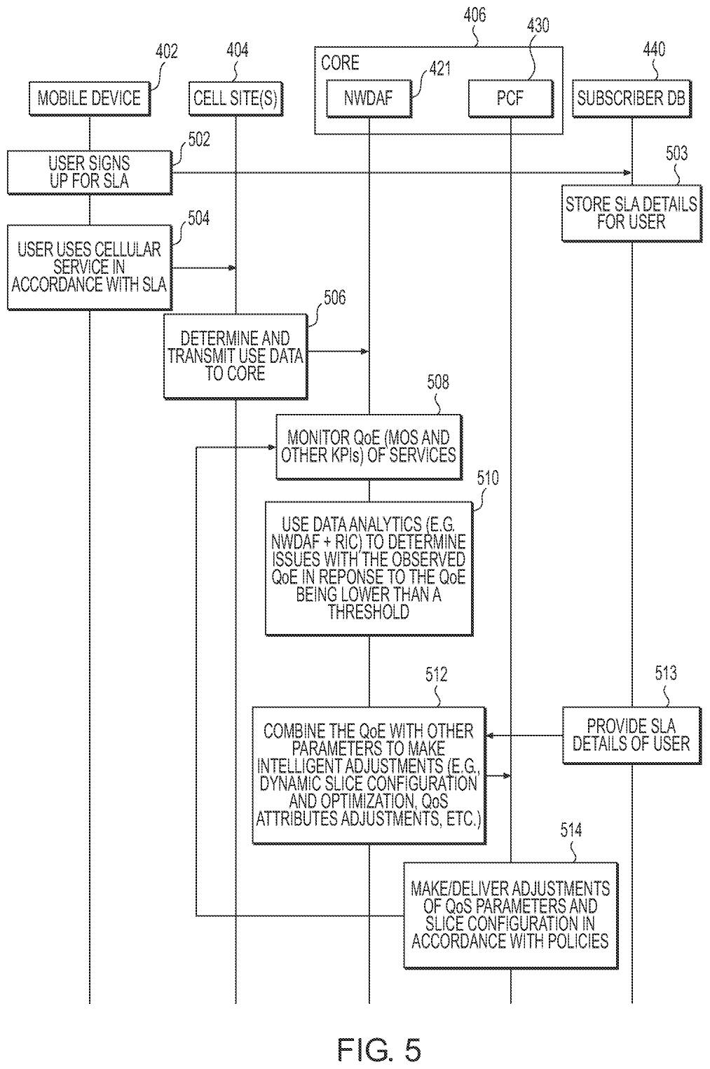

These above solutions will be discussed more below with reference to FIGS. 4 and 5.

First, FIG. 4 illustrates an embodiment of a mobile device 402 (which could be a mobile cellular phone), a cell site 404 and a core network 425. The core network 425 could include NWDAF 406, QoS parameters database 390, and a policy function control (PCF) 430.

Referring first to the mobile device 402, the mobile device 402 includes an interface 407, an antenna 408, a processor 409, memory 410, applications/controls 411, a GPS module 412, and electronics 413. Each of these components is discussed in greater detail below.

The antenna 408 is configured to transmit and receive voice/text/data signals from a wireless connection on the network via at least one cell site 404. These signals are then processed by the processor 409 and software in the mobile device 402.

The processor 409 may be a hardware processor (e.g., CPU) that is configured to execute instructions stored in memory 410. The processor 409 is configured to interact with each of the applications/modules 411, 412, 413 and stored data and other software and/or data stored in the memory 410.

Any of the applications/modules 411, 412, 413 and other software modules or data may be stored in the memory 410. The memory 410 may be any type of temporary or persistent storage device capable of storing instructions and data. The memory 410 may be internal and/or external to the mobile device 402 and may include one or more storage devices. In one embodiment, the memory 410 is a non-transitory computer readable storage medium having a physical presence configured for long term and/or short term storage of data. For example, the memory 410 may be an internal hard drive, chip, or flash memory.

The applications/controls 411 is software with instructions that are executed by the processor 409 to perform functions of the mobile device 402. Examples of the applications/controls 411 may be to control the antenna of the phone to make calls, track the phones location, determine the time of use of cellular services, send/receive text messages or other data, and the like. The applications/controls 411 is configured to control one or more components of the mobile device 402 as desired by the user using the interface 407 (via a graphical user interface on the screen) of the mobile device 402.

The electronics 413 of the mobile device 402 are configured to work with the processor 409, memory 410 and antenna to send/receive signals to/from the network via the cell site 404, to send the mobile device's location to the cell site 404, or to perform other cellular operations. The electronics 413 may include a screen, logic to interconnect the hardware, and logic to process the signals to be sent and signals received.

The interface 407 includes not only GUIs for the user but a communications interface that works with the antenna 408 to communicate with the cell site 404, which includes the cell site server 414, base station 415, and electronics 417.

As mentioned above, the location of the mobile device 402 (or any other cellular wireless device) may be determined (using the GPS module 412 as a non-limiting example) and there are various methods and advantages to this. Indeed, the ability to locate cellular wireless mobile phones has the advantages for determining QoS for the user, such as if the user is located at an event where a lot of cellular users are located (which could significantly load a single tower). A number of infrastructure-based, handset-based and network-based wireless location systems can be employed to locate the mobile phone while the mobile phone is active and transmitting/receiving signals.

Infrastructure-based location techniques for locating mobile phones 402 use information in use within the network (such as cell site 404) to generate an approximate geographic location. Infrastructure-based location techniques include CID (serving Cell-ID), CID-RTF (serving cell-ID plus radio time-of-flight time-based ranging), CIDTA (serving cell-ID plus time-based ranging), and Enhanced Cell-ID (ECID, a serving cell, time-based ranging and power difference of arrival hybrid). Signals that generate the network information that is the precursor to infrastructure-based location may be collected at the mobile device 402 or at the base station 415 of a cell site 404 and delivered to a mobile location server 414 which has database knowledge of both the network topology and geographic topology of the clustered network described in FIGS. 1-3. This is completed for each cell site 404 of a plurality of cells sites within the clustered network.

Other techniques for locating a mobile device may also be employed such as network-based techniques, mobile-device based location solutions, and hybrids thereof. These location determination systems enable robust and effective location-determination performance when adequate data can be derived or are otherwise available.

Referring now to the cell site 404, as discussed above, the cell site 404 includes a server (such as mobile location server 414), a base station 415 and electronics 417. The base station 415 includes a tower to directly transmit/receive signals to/from the mobile device 402 and converts these signals into a format usable by the server 414. The processor 416 may be a hardware processor (e.g., CPU) that is configured to execute instructions stored in memory 418 and/or storage system 419. The processor 416 is configured to store data (e.g., location data, movement behavior, analysis, CDRs, etc.) stored in the memory 418 and execute software instructions. For example, the processor 416 is configured to perform at least one or more or all of the steps presented herein, including those shown in FIG. 5.

The memory 418 may be any type of temporary or persistent storage device capable of storing instructions and data. The memory 418 may be internal and/or external to the cell site 404 and may include one or more storage devices. In one embodiment, the memory 418 is a non-transitory computer readable storage medium having a physical presence configured for long term and/or short term storage of data. For example, the memory 418 may be an internal hard drive or flash memory.

The cell site 404 is configured to communicate with the location determination server 406 over a network 403, such as the Internet, a local area network (LAN), or a wide area network (WAN).

The mobile device 402 communicates with the cell site via a base station at a first time at a first location. While the mobile device 402 is performing such communications, CDRs are being created and each CDR includes a timestamp, where the mobile device 402 is located at each respective at the timestamp, the data sent or number called, the cell being used at the timestamp, identification of the mobile device 402 communicating with the cell site, and the like.

The cell site 404 then saves each CDR in memory 418 at the cell site 404. In other embodiments, the CDRs are stored on the core network in a public cloud where the core network resides. Since the core network is implemented in the cloud, the saving of the CDRs also occurs in the cloud as well.

Turning now to the core network 406, according to embodiments of the present application, the core network 406 determines the QoE, checks the QoE and then intelligently adjusts the QoS parameters to deliver better QoE for the user. The core network 406 includes at least a processor 420, memory 422, and NWDAF 421 which includes a module for observing QoE 424 and a module for intelligently adjusting QoE 426. Each of these components is discussed in greater detail below.

The processor 420 may be a hardware processor (e.g., CPU) that is configured to execute instructions stored in memory 422. The processor 420 is configured to interact with each of the modules 424, 426 of NWDAF and PCF and stored data 440, 390 and other software and/or data stored in the memory 422 or databases. For example, the processor 420 is configured to perform at least one or more or all of the steps presented herein, including those shown in FIG. 5.

Any of the applications/modules 424, 426 and other software modules or data may be stored in the memory 422. The memory 422 may be any type of temporary or persistent storage device capable of storing instructions and data. The memory 422 may be internal and/or external to the server 406 and may include one or more storage devices. In one embodiment, the memory 422 is a non-transitory computer readable storage medium having a physical presence configured for long term and/or short term storage of data. For example, the memory 410 may be an internal hard drive or flash memory.

The module for observing QoE 424 and module for intelligently adjusting QoE 426 may be software with instructions that are executed by the processor 420 to perform functions of the FIG. 5. As mentioned above, the QoE is the measure of the customer experience and begins by measuring or observing the MOS and other KPIs. The module for observing QoE 424 is configured to receive such MOS and KPI data. This may be accomplished by receiving various observability data including the QoS parameters mentioned above (e.g., maximum bit rate, guaranteed bit rate, latency, jitter, packet loss, priority, etc.) for a particular user's cellular use (e.g., voice calls, cellular data downloads/uploads, etc.). Other data relating to the MOS and KPI data may also be received including the parameters relating to the user, including the location and time of the user's use of the cellular network services, the slice being used, the user's profile settings (e.g., the user's predetermined settings for using the network), and the like.

The core network receives such data by collecting such data from cell sites 404 (via the cluster the user is using) and via operations on the core network 406. The various data is received over a network 403 that connects the cell site clusters located in a private cloud to the core network located in a public cloud, as discussed above herein, and then such data is stored in a database of QoS parameters 429, as shown in FIG. 4. The database of QoS parameters 429 may be stored in the core network 406 or be remote from the core network 406 and communicate with the core network 406 via the network 406 or other network.

Once the QoS parameters 429 are stored, they are then used by NWDAF 421 which monitors such QoE measurements to determine if the QoS parameters or other network functions should be adjusted to increase the user's QoE.

After (and/or during) the monitoring of the QoE via the module for observing QoE 424, the module for intelligently adjusting QoE 426 part of NWDAF 426 uses data analytics, i.e., NWDAF (+RIC), to check the observed QoE. In this regard, NWDAF via the module for intelligently adjusting QoE 426 determines which QoS parameters may be negatively affecting the QoE for the user. For example, if the maximum bit rate is below a predefined threshold needed for the user to meet the user's needs, the module for intelligently adjusting QoE 426 may determine that the bit rate for the user's call or data use needs to be increased, which may be done by switching the slice being used, providing in real time an increase in bandwidth for the user, etc. By way of another example, the module for intelligently adjusting QoE 426 may detect that the packet loss is also an issue and that the user's location is in an area where there is high network traffic (such as at a concert). In this regard, the module for intelligently adjusting QoE 426 may determine that modification of the configuration of the network resources for the user should be adjusted to compensate for such parameters.

In any event, the module for intelligently adjusting QoE 426 may determine that there are one or a plurality of reasons (e.g., network resources, time, location, etc.) for the user's QoE to be below the user's predefined threshold.

The module for intelligently adjusting QoE 426 may include AI/ML engines to determine or identify the issues or potential issues including the QoS parameters. For example, the QoE may be analyzed using AI/ML to determine which QoS parameter (or parameters) are causes for the QoE of the user to be below the predefined threshold for the user. The AI/ML engines also intelligently determine the solution to correct such underperforming network resource or other factor (e.g., time, location, assigned slice, etc.) affecting the user's QoE to adjust the QoS parameters. These adjustments may be preset or determined based on predetermined inputs set up by the network administrator. This is discussed in more detail with regard to FIG. 5.

The PCF 430 assists service data flow detection, policy enforcement, and flow-based charging, which ensures the reliable monitoring of services or use cases. It also enables the reconfiguration of policies to effectively manage QoS, quota, optimization, and admission control. The PCF 430 further supports the unified policy framework that governs network behavior by providing policy rules for control plane functions (such as network slicing, roaming and mobility management) and subscription information from the subscriber database 440 for the policy decisions taken. In this regard, the PCF 430 is used in conjunction with NWDAF 421 to intelligently manage and adjust the QoS parameters/slice configuration. In one embodiment, the PCT 430 is configured to receive instructions to adjust the QoS parameters/slice configuration from NWDAF 421 after NWDAF 421 determines the QoS parameters/slice configuration to adjust.

FIG. 5 illustrates a method for monitoring and adjusting QoE in a cellular network, in accordance with some embodiments.

As shown at block 502, a user signs up for an SLA which provides the level of service the user requires from the cellular network. Then, in block 504, the mobile device 402 communicates with the cellular towers to perform voice calling, data downloads/uploads or any other use of the cellular network from the mobile device 402. In this regard, the cell site 404 then receives mobile device's voice or data as well as other data including the location, the times associated with the corresponding locations, etc.

As shown in block 506, the cell site 404 then may transmit the use data and observability data to the core network 406 which includes the NWDAF and PCF. This data could include the MOS and any of the KPIs to be saved in the QoS parameter database 429 which then may be used by the NWDAF 421 and/or PCF 430 as part of the core network 406. It should be understood that the NWDAF 421 and/or PCF 430 may be located outside of the core network 406 and the present invention should not be limited to the NWDAF 421 and/or PCF 430 being part of the core network 406.

In any event, the process repeats from blocks 502 to 506 continually obtain data about the mobile device's QoE. This allows the NWDAF to monitor the QoE to measure the performance from the end-user perspective to gain a better understanding of human quality metrics and be able to actually measure whether performance met a user's expectations, as mentioned above.

In block 508, NWDAF 421 (as part of or separate from the core network 406) monitors the QoE of the user. As previously discussed, this is done by receiving the MOS and KPIs stored in the QoS parameters database 429. To do this, NWDAF 421 may request or continually receive the KPIs from the QoS parameters database 429. The KPIs provide any and/or all data relating to the user's QoE.

After receiving the KPIs from the QoS parameters database 429, the NWDAF 421 then makes a determination, in block 510, as to whether the mobile device activity and thus, QoE meets a predefined threshold level associated with the user. As mentioned above, the NWDAF uses data analytics (e.g., AI/ML) for checking the QoE in response to the QoE being less than the predefined threshold level. This may be based on certain predefined QoS parameters, MOS, time, location, slice or any other parameters/criteria. Each of the criteria is input for the data analytics and AI/ML may be used to determine the QoE and compare such determined QoE meets the predefined threshold level. If QoE exceeds the predetermined threshold, then no action needs to be taken. However, if the QoE is less than the predetermined threshold (meaning the user experience is less than expected), the AI/ML engine may determine that adjustments to the QoS parameters need to be taken.

Adjustments may be determined based on the discussions above relative to FIG. 4. For example, the AI/ML engine of NWDAF 421 may determine which QoS parameter(s) need adjustment and intelligently identify to the PCF 430 the adjustments needed. Accordingly, in block 512, the QoE is combined with other parameters to make intelligent adjustments, such as dynamic slice configurations and optimization, QoS attribute adjustments, and/or pro-actively adapt the resource allocation for a given time window. This is all done to deliver the SLA. For example, the user may be switched to a different slice that has better performance or is under used or the current slice of the user may be modified to provide better performance for the user. In order to do this, NWDAF 421 may access the subscriber database 440 and the SLA to determine the level of service the user is required to have based on the SLA with the user. Other parameters and requirements may also be determined from the subscriber database 440 as well so the NWDAF 421 and PCF 430 make sufficient adjustments required to raise the QoE to the required level dictated by the SLA.

In order to perform the intelligent adjustments, some probabilistic machine learning algorithms can be used by the AI/ML engines mentioned above: (1) LCM algorithm (Latent class model) for probabilistic classification can be used to check with what probability the QoS parameters will properly adjust the QoE; and (2) Bayesian classifiers can be used for filtration (e.g., spam filtration), classifying analysis (same as LCM), etc. Some other methods are: Logistic Regression, Hidden Markov model, Neural Networks, etc.

In block 514, the PCF 430 works with the NWDAF 421 to make and deliver the determined adjustments to the QoS parameters and slice configurations in accordance with the policies of the PCF 430. Once the adjustments have been made, the method may continue back to block 508 to continue to monitor and adjust the QoE.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a radio access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

What is claimed is:

1. A cellular network system comprising:
a radio access network (RAN) comprising:
cell sites configured to deliver key performance indicator (KPI) data to a quality of service (QoS) parameter database;
a core network comprising a network data analytics function (NWDAF) configured to:
monitor quality of experience (QoE) of a user of cellular services using the KPI data from the QoS parameter database;
determine, using data analytics, network configuration parameters to adjust in response to determining that the monitored QoE is below a predetermined threshold set for the user; and
adjust the determined network configuration parameters until the monitored QoE reaches the predetermined threshold.

2. The system of claim 1, wherein the determined network configuration parameters comprise at least one of: QoS parameters and network slice configuration for the user.

3. The system of claim 2, wherein the QoS parameters comprise: maximum bit rate, guaranteed bit rate, latency, jitter, packet loss, and priority such that adjusting the QoS parameters changes the QoE of the user.

4. The system of claim 1, wherein the QoE being monitored includes a mean opinion score (MOS), time and location of use of services of the RAN, and an identified network slice.

5. The system of claim 1, further comprising determining if the QoE for the user is less than the predetermined threshold set for the user based on a service level agreement (SLA) for the user.

6. The system of claim 5, wherein the QoE measures performance from a perspective of the user to determine if such performance meets the predetermined threshold.

7. The system of claim 1, wherein the RAN further comprises: a central unit (CU); and a series of clusters that each comprise a distributed unit (DU) that communicates with the CU and cellular towers over a network, wherein each respective cluster creates and then transmits the KPI data from the DU of the cluster to the core network.

8. A server configured to communicate with a radio access network (RAN) that includes cell sites and a core network, the server includes:
a processor configured to perform a network data analytics function (NWDAF) comprising:
monitor quality of experience (QoE) of a user of cellular services using key performance indicator (KPI) data stored in a quality of service (QoS) parameter database;
determine, using data analytics, network configuration parameters to adjust in response to determining that the monitored QoE is below a predetermined threshold set for the user; and
adjust the determined network configuration parameters until the monitored QoE reaches the predetermined threshold.

9. The server of claim 8, wherein the determined network configuration parameters comprise at least one of: QoS parameters and network slice configuration for the user.

10. The server of claim 9, wherein the QoS parameters comprises: a maximum bit rate, a guaranteed bit rate, latency, jitter, packet loss, and priority such that adjusting the QoS parameters changes the QoE of the user.

11. The server of claim 8, wherein the QoE being monitored include includes a mean opinion score (MOS), time and location of use of services of the RAN, and network slice.

12. The server of claim 8, wherein the processor is configured for determining when the QoE for the user is less than the predetermined threshold set for the user based on a service level agreement (SLA) for the user.

13. The server of claim 12, wherein the QoE measures performance from a perspective of the user to determine if such performance meets the predetermined threshold.

14. The server of claim 8, wherein the RAN further comprises a central unit (CU); and a series of clusters that each comprise a distributed unit (DU) that communicates with the CU and cellular towers, wherein each respective cluster creates and then transmits the KPI data from the DU of the cluster to the core network.

15. A method for improving quality of experience (QoE) of a user of a cellular network comprising:
monitoring quality of experience (QoE) of a user of cellular services using key performance indicator (KPI) data stored in a quality of service (QoS) parameter database;
determining, using data analytics, network configuration parameters to adjust in response to determining that the monitored QoE is below a predetermined threshold set for the user; and
adjusting the determined network configuration parameters until the monitored QoE reaches the predetermined threshold.

16. The method of claim 15, wherein the determined network configuration parameters comprise at least one of: QoS parameters and network slice configuration for the user.

17. The method of claim 16, wherein the QoS parameters comprises maximum bit rate, guaranteed bit rate, latency, jitter, packet loss, and priority such that adjusting the QoS parameters changes the QoE of the user.

18. The method of claim 15, wherein the QoE being monitored include includes a mean opinion score (MOS), time and location of use of services of the RAN, and network slice.

19. The method of claim 15, further comprising determining if the QoE for the user is less than the predetermined threshold set for the user based on a service level agreement (SLA) for the user.

20. The method of claim 19, wherein the QoE measures performance from a perspective of the user to determine if such performance meets the predetermined threshold.
